(19) United States
(12) Patent Application Publication
(10) Pub. No.: US 2025/0074401 A1
(43) Pub. Date: Mar. 6, 2025

(54) VEHICLE CONTROL DEVICE, VEHICLE CONTROL METHOD AND PROGRAM

(71) Applicant: TOYOTA JIDOSHA KABUSHIKI KAISHA, Toyota-shi (JP)

(72) Inventor: Kurumi OKA, Toyota-shi (JP)

(73) Assignee: TOYOTA JIDOSHA KABUSHIKI KAISHA, Toyota-shi (JP)

(21) Appl. No.: 18/760,221

(22) Filed: Jul. 1, 2024

(30) Foreign Application Priority Data
Aug. 31, 2023 (JP) 2023-141309

(51) Int. Cl. B60W 30/09; B60W 50/14

(52) U.S. Cl. CPC B60W 30/09; B60W 50/14; B60W 2050/143; B60W 2554/80

(57) ABSTRACT

To effectively prevent the driver from being troublesome, provided is a vehicle control device configured to execute an alarm and an automatic brake for avoiding an own vehicle from collide with an object, when a distance between the own vehicle and the object becomes less than or equal to a predetermined threshold value. The vehicle control device is configured to determine whether or not a specific condition in which a current position of the own vehicle is located at a predetermined registered location is satisfied, and change the threshold value so that the alarm and the automatic brake are difficult to be activated, when the specific condition is satisfied.

### CROSS-REFERENCE TO RELATED APPLICATION

This application claims priority to Japanese Patent Application No. JP2023-141309 filed on Aug. 31, 2023, the content of which is hereby incorporated by reference in its entirety into this application.

### BACKGROUND OF THE INVENTION

### 1. Field of the Invention

The present disclosure relates to a vehicle control device, a vehicle control method and a program.

### 2. Description of the Related Art

For example, Japanese Patent Application Laid-Open (kokai) No. 2002-120679 discloses a device that estimates whether or not an own vehicle is likely to come into collide with an obstacle in the near future from the transition of the distance between the own vehicle and the obstacle in the surroundings, and alarms drivers of the own vehicle when it is estimated that there is a high possibility of collision.

Generally, an alarm or an automatic brake (so-called collision avoidance assistance) for avoiding collision between the own vehicle and the obstacle or reducing damage caused by a collision activates when the distance from the own vehicle to the obstacle becomes equal to or less than a predetermined threshold. However, even in a case where the driver parks the vehicle in the home parking lot or the like and parks the vehicle at a relatively short distance with respect to the obstacle, if the alarm or the automatic brake is activated without changing the threshold value, the alarm or the automatic brake is activated before the vehicle reaches the parking position desired by the driver. In this case, the driver has to wait for the automatic brake to be released and then park again, which has a problem of giving troublesomeness to the driver.

### SUMMARY OF THE INVENTION

It is an object of the present disclosure is to effectively prevent the driver from being troublesome by optimizing the activating conditions of the collision avoidance assistance.

A device according to at least one embodiment of the present disclosure is a vehicle control device configured to execute either or both an alarm and an automatic brake for avoiding an own vehicle from collide with an object, when a distance between the own vehicle and the object detected by a sensor for detecting the object present around the own vehicle becomes less than or equal to a predetermined threshold value. The vehicle control device is configured to determine whether or not a specific condition in which a current position of the own vehicle is located at a predetermined registered location is satisfied, and change the threshold value so that either or both the alarm and the automatic brake are difficult to be activated, when the specific condition is satisfied.

A method according to at least one embodiment of the present disclosure is a vehicle control method which is applied to a vehicle. The vehicle comprising a control device configured to executes either or both an alarm and an automatic brake for avoiding an own vehicle from collide with an object, when a distance between the own vehicle and the object detected by a sensor for detecting the object present around the own vehicle becomes less than or equal to a predetermined threshold value. The vehicle control method comprising determining whether or not a specific condition in which a current position of the own vehicle is located at a predetermined registered location is satisfied, and changing the threshold value so that either or both the alarm and the automatic brake are difficult to be activated, when the specific condition is satisfied.

A program according to at least one embodiment of the present disclosure is the program which is applied to a vehicle. The vehicle comprising a control device configured to executes either or both an alarm and an automatic brake for avoiding an own vehicle from collide with an object, when a distance between the own vehicle and the object detected by a sensor for detecting the object present around the own vehicle becomes less than or equal to a predetermined threshold value. The program causes an electronic control unit of the vehicle to execute determining whether or not a specific condition in which a current position of the own vehicle is located at a predetermined registered location is satisfied, and changing the threshold value so that either or both the alarm and the automatic brake are difficult to be activated, when the specific condition is satisfied.

### BRIEF DESCRIPTION OF THE DRAWINGS

FIG. 1 is a schematic diagram showing a hardware configuration of a vehicle to which a control device according to the present embodiment is applied.

FIG. 2 is a schematic diagram showing an example of installation of a sonar sensor.

FIG. 3 is a schematic diagram showing a software configuration of a control device to the present embodiment.

FIG. 4A is a schematic overhead view for explaining a device according to the present embodiment that executes a threshold value changing process.

FIG. 4B is a schematic overhead view for explaining a device according to a comparative embodiment that does not execute the threshold value changing process.

FIG. 5 is a flow chart for explaining a routine of collision avoidance assistance control and threshold value changing process according to the present embodiment.

### DESCRIPTION OF THE EMBODIMENTS

Description is now given of a vehicle control device, a vehicle control method and a program according to at least one embodiment of the present disclosure with reference to the drawings.

### Hardware Configuration

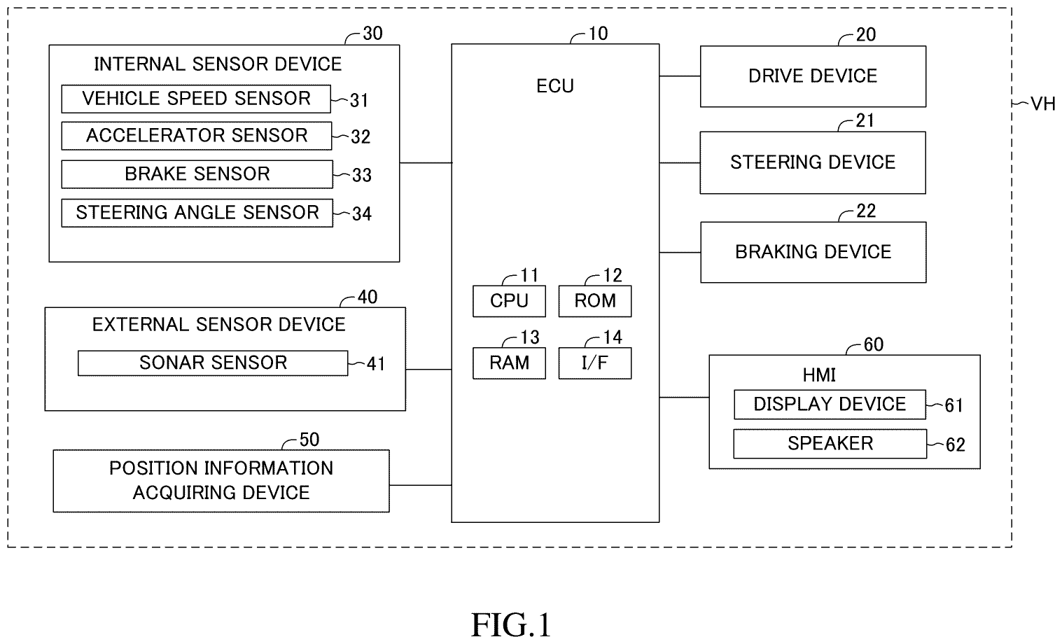

FIG. 1 is a schematic diagram of a hardware configuration of a vehicle VH to which the control device according to the present embodiment is applied. Hereinafter, the vehicle VH may be referred to as an own vehicle when it is required to distinguish it from other vehicles.

The vehicle VH has an ECU (Electronic Control Unit) 10. The ECU 10 includes a CPU (Central Processing Unit) 11, ROM (Read Only Memory) 12, RAM (Random Access Memory) 13, an interface device 14, and the like. The CPU 11 executes various programs stored in the ROM 12. The ROM 12 is a non-volatile memory that stores data and the like required for the CPU 11 to execute various programs. The RAM 13 is a volatile memory to provide a working region that is deployed when various programs are executed by the CPU 11. The interface device 14 is a communication device for communicating with an external device.

The ECU 10 is a central device which executes a driver assistance control of the vehicle VH, such as a collision avoidance assistance control described later, and the like. The driver assistance control is a concept which encompasses automatic driving control. A drive device 20, a steering device 21, a braking device 22, an internal sensor device 30, an external sensor device 40, a position information acquiring device 50, a HMI (Human Machine Interface) 60, and the like are communicably connected to the ECU 10.

The drive device 20 generates a driving force to be transmitted to driving wheels of the vehicle VH. As the drive device 20, for example, an engine and a motor are given. In the device according to the at least one embodiment, the vehicle VH may be any one of a hybrid electric vehicle (HEV), a plug-in hybrid electric vehicle (PHEV), a fuel cell electric vehicle (FCEV), a battery electric vehicle (BEV), and an engine vehicle. The steering device 21 applies steering forces to steerable wheels of the vehicle VH. The braking device 22 applies a braking force to the wheels of the vehicle VH.

The internal sensor device 30 is sensors which acquire states of the vehicle VH. Specifically, the internal sensor device 30 includes a vehicle speed sensor 31, an accelerator sensor 32, a brake sensor 33, a steering angle sensor 34, and the like.

The vehicle speed sensor 31 detects a travel speed (vehicle speed v) of the vehicle VH. The accelerator sensor 32 detects an operation amount of an accelerator pedal (not shown) by the driver. The brake sensor 33 detects an operation amount of a brake pedal (not shown) by the driver. The steering angle sensor 34 detects a rotational angle of a steering wheel or a steering shaft (not shown) of the vehicle VH, that is, a steering angle. The internal sensor device 30 transmits the condition of the vehicle VH detected by the sensors 31 to 34 to the ECU 10 at a predetermined cycle.

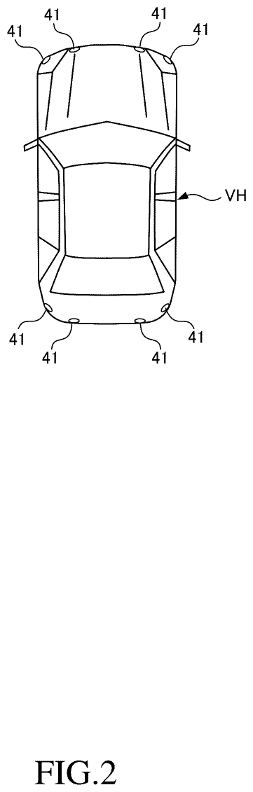

The external sensor device 40 is sensors which acquire object information on objects around the vehicle VH. Specifically, the periphery recognition device 40 includes a sonar sensor 41. As the object information, there are given, for example, a stationary object such as a wall, and a moving object such as a surrounding vehicle or a pedestrian. The sonar sensor 41 emits an ultrasonic wave and receives a reflected wave reflected by a target object existing in the emission range, thereby acquiring distance and the like between the vehicle VH and the target object. The number of the sonar sensors 41 is not particularly limited, as an example, as shown in FIG. 2, the sonar sensor 41, two at predetermined intervals in the vehicle width direction in front of the front bumper of the vehicle VH, each one at the left and right ends of the front bumper, two at predetermined intervals in the vehicle width direction in front of the rear bumper, each one at the left and right ends of the rear bumper total eight are provided.

The external sensor device 40 repeatedly transmit the acquired object information to the ECU 10 each time a predetermined time elapses. Note that the external sensor device 40 is not limited to the sonar sensor 41, and may include a millimeter wave radar, a Lidar, a camera sensor, and the like.

The position information acquiring device 50 acquires the present position information of the vehicle VH. As the position information acquiring device 50, for example, a GPS (Global Positioning System), a GNSS (Global Navigation Satellite System) or the like included in a navigation device (not shown) can be used.

The HMI 60 is an interface for inputting and outputting data between the ECU 10 and the driver, and includes an input device and an output device. Examples of the input device include a touch panel, a switch, and a sound pickup microphone. Examples of the output device include a display device 61 and a speaker 62. The display device 61 is, for example, a center display installed in an instrument panel or the like, a multi-information display, a head-up display, a display of a navigation system, or the like. The speaker 62 is, for example, a speaker of an acoustic system or the navigation system.

### Software Configuration

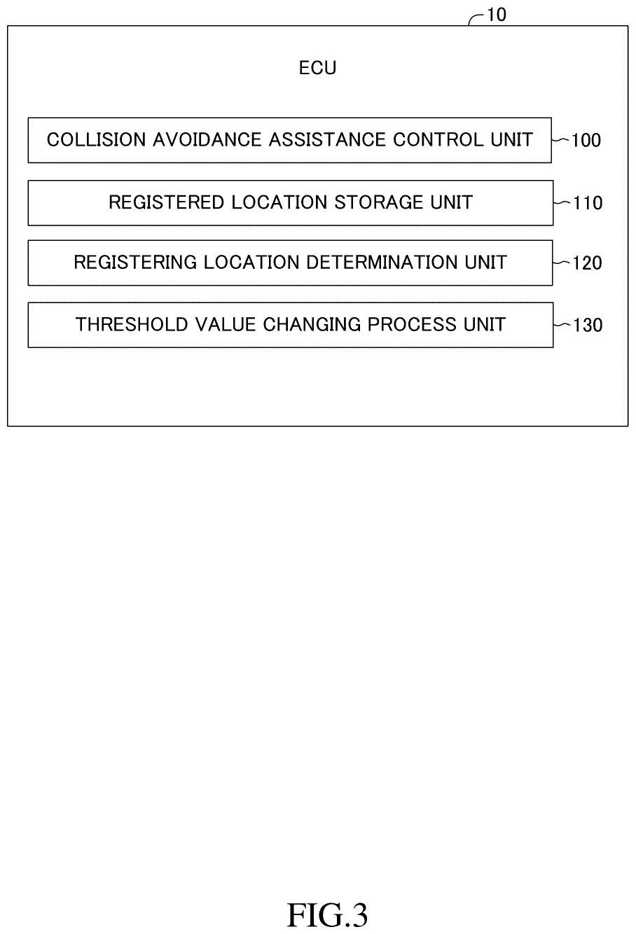

FIG. 3 is a schematic diagram showing a software configuration of the ECU 10 to the present embodiment. As shown in FIG. 3, the ECU 10 includes a collision avoidance assistance control unit 100, a registered location storage unit 110, a registering location determination unit 120, a threshold value changing process unit 130, and the like as a part of functional elements. Those functional elements 100 to 130 are realized by the CPU 11 of the ECU 10 reading a program stored in the ROM 12 into the RAM 13 and executing the program. Note that all or a part of the functional elements 100 to 130 may be provided in another ECU separate from the ECU 10 or in an information processing device of a facility (a control center or the like) capable of communicating with the vehicle VH.

The collision avoidance assistance control unit 100 activates the speaker 62 to output an alarm sound corresponding to the distance to an obstacle detected in the traveling direction of the own vehicle VH by the external sensor device 40. Specifically, the collision avoidance assistance control unit 100 activates the speaker 62 to emit the alarm sound, when the distance to the obstacle becomes equal to or smaller than the predetermined reference alarm threshold value Dv1. Further, the collision avoidance assistance control unit 100 shortens the intermittent cycle of the alarm sound or increases the volume of the alarm sound as the distance to the obstacle becomes shorter. The distance D from the own vehicle VH to the obstacle may be acquired based on the detection result of the sonar sensor 41.

Further, the collision avoidance assistance control unit 100 determines that the own vehicle VH may collide with the obstacle when the distance to the obstacle detected in the own vehicle VH traveling direction becomes equal to or smaller than a predetermined reference automatic brake threshold value Dv2. When determining that there is a possibility of collision with the obstacle, the collision avoidance assistance control unit 100 transmits an operation signal to the braking device 22, and activates the automatic brake that automatically applies a braking force to the own vehicle VH.

Here, the reference automatic brake threshold value Dv2 is set to be smaller than the reference alarm threshold value Dv1 (Dv2<Dv1). That is, when the own vehicle VH comes closer to the obstacle even though the driver is alerted, the automatic brake is activated. Accordingly, it is possible to effectively prevent the own vehicle VH from contacting or colliding with the obstacle.

The registered location storage unit 110 stores, as a registered location, location information of a location where the driver desires to reduce the activation of the collision avoidance assistance. Examples of the location where the driver desires to reduce the activation of the collision avoidance assistance include the location where the vehicle VH must be parked at a relatively short distance with respect to the obstacle, such as a home parking lot where the parking area is narrow. When receiving the registering request from the driver, the registered location storage unit 110 stores the location information of the vehicle VH acquired by the location information acquisition device 50 at that time as the location information of the registered location. The driver registering request may be acquired by, for example, an operation of a touch type switch image displayed on the display device 61, an operation of a physical switch provided separately from the display device 61, or speech recognition by a sound collector.

The registering location determination unit 120 determines whether or not the vehicle VH exists in the registered location stored by the registered location storage unit 110. Specifically, the registering location determination unit 120 determines whether or not the present position of the vehicle VH is within a predetermined distance range (for example, several meters) from the registered location. When the present position of the vehicle VH is within the predetermined distance range from the registered location, the registering location determination unit 120 determines that the vehicle VH is present at the registered location. The present position information of the vehicle VH may be acquired on the basis of the position information acquiring device 50. The predetermined distance range is not particularly limited, but may be set to an appropriate range corresponding to the accuracy of detecting the GPS or the GNSS. When determining that vehicle VH exists in the registered location, the registering location determination unit 120 transmits the determination result to the threshold value changing process unit 130.

The threshold value changing process unit 130 executes a threshold value changing process for making it difficult to activate the alarm and the automatic brake by decreasing the reference alarm threshold value Dv1 and the reference automatic brake threshold value Dv2, when the obstacle is detected in the traveling direction of the own vehicle VH and it is determined that the own vehicle VH is present at the registered location. Hereinafter, the changed alarm threshold value is referred to as a “changed alarm threshold value Dv1′”, and the changed automatic brake threshold value is referred to as a “changed automatic brake threshold value Dv2′”. The changed alarm threshold value Dv1′ is a value smaller than the reference alarm threshold value Dv1 (Dv1′<Dv1), and the changed automatic brake threshold value Dv2′ is a value smaller than the reference automatic brake threshold value Dv2 (Dv2′<Dv2).

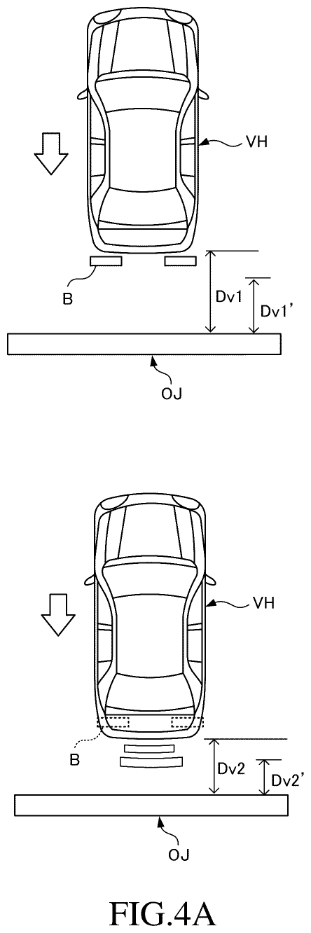

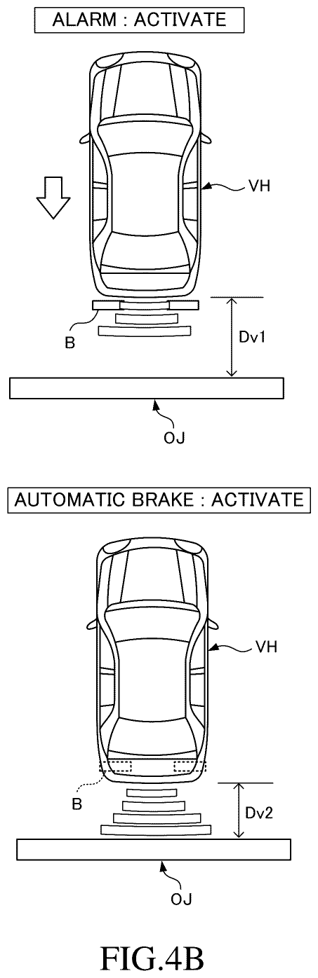

FIG. 4A and 4B are a schematic overhead view for explaining the device according to the present embodiment that executes the threshold value changing process and a device according to a comparative embodiment that does not execute the threshold value changing process when the driver parks the vehicle VH in a narrow parking lot (for example, the home parking lot or the like). First, a description will be given of the comparative example in which the threshold value changing process is not executed, which is illustrated in FIG. 4B.

As shown in FIG. 4B, in the device of the comparative example in which the threshold value changing process is not executed, when the distance between the own vehicle VH and the obstacle OJ such as a wall or the like in the traveling direction of the own vehicle VH becomes equal to or smaller than the reference alarm threshold value Dv1, the alarm sound is activated (refer to the upper row of FIG. 4B). As the own vehicle VH approaches the obstacle OJ, the alarm sound become progressively shorter in the intermittent cycle, or the volume is progressively increased. In the device of the comparative example, when the own vehicle VH approaches the obstacle OJ further and the distance between the own vehicle VH and the obstacle OJ becomes equal to or smaller than the reference automatic brake threshold value Dv2, the automatic brake is activated even before the own vehicle VH reaches the parking position (in the illustrated example, the vehicle stop B) desired by the driver (refer to the lower part of FIG. 4B). In such a case, the driver needs to wait for the automatic brake to be released and then park again. That is, in the device of the comparative example, the driver is troublesome.

On the other hand, as shown in FIG. 4A, in the device of the present embodiment, even if the distance between own vehicle VH and the obstacle OJ becomes equal to or smaller than the reference alarm threshold value Dv1, the alarm threshold value is changed to the changed alarm threshold value Dv1′, which is a smaller value, by threshold value changing process, so that the alarm sound is not activated (refer to the upper part of FIG. 4A). Further, in the device of the present embodiment, even if the distance between the own vehicle VH and the obstacle OJ becomes equal to or smaller than the reference automatic brake threshold value Dv2, the automatic brake threshold value is changed to the changed automatic brake threshold value Dv2′, which is a smaller value, by the threshold value changing process, so that the automatic brake is not activated (refer to the lower part of FIG. 4A).

That is, it is configured to effectively prevent the automatic brake from being activated prior to the own vehicle VH reaching the parking position desired by the drivers. As described above, when the vehicle VH is parked in the parking lot of the registered location registered in advance by the driver, the alarm or the automatic brake is not activated until the distance between the own vehicle VH and the obstacle OJ becomes a shorter distance than usual, so that the activation frequency of the alarm or the automatic brake is reduced, and the troublesomeness of the driver can be effectively reduced.

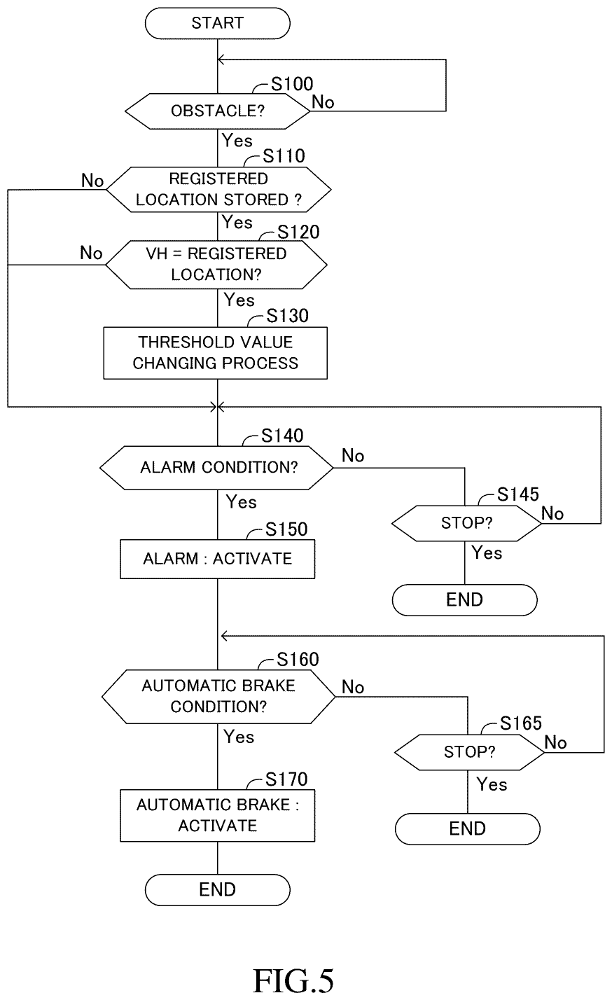

Next, a routine of control process by the CPU 11 of the ECU 10 will be described with reference to FIG. 5. This routine is started, for example, when the vehicle speed V decreases to a predetermined vehicle speed while the own vehicle VH is traveling.

In step S100, the ECU 10 determines whether or not the obstacle is detected in the traveling direction of the own vehicle VH. If the obstacle is detected (Yes), the ECU 10 advances the process to step S110. On the other hand, if the obstacle is not detected (No), the ECU 10 returns this routine.

In step S110, the ECU 10 determines whether the registered location is stored that reduces the activation of the collision avoidance assistance. If the registered location is stored (Yes), the ECU 10 advances the process to step S120. On the other hand, if the registered location is not stored (No), the ECU 10 returns this routine.

In step S120, the ECU 10 determines whether or not the present position of the vehicle VH is within a predetermined distance from the registered location, that is, whether or not the vehicle VH is present at the registered location. If the vehicle VH is present at the registered location (Yes), the ECU 10 advances the process to step S130. On the other hand, if the vehicle VH does not exist at the registered location (No), the ECU 10 advances the process to step S140.

In step S130, the ECU 10 executes the threshold value changing process that changes the reference alarm threshold value and the reference automatic brake threshold value to small values.

Next, in step S140, the ECU 10 determines whether or not the activation condition of the alarm is satisfied. Specifically, when the process advances to step S140 without passing through the threshold value changing process of step S130, the ECU 10 determines whether or not the distance D between the own vehicle VH and the obstacle OJ is equal to or less than the reference alarm threshold value Dv1. On the other hand, if the process advances to step S140 through the threshold value changing process of step S130, the ECU 10 determines whether or not the distance D between own vehicle VH and the obstacle OJ is equal to or less than the changed alarm threshold value Dv1′. If the activation condition of the alarm is satisfied (Yes), the ECU 10 advances the process to step S150. On the other hand, if the activation condition of the alarm is not satisfied (No), the ECU 10 advances the process to step S145.

In step S145, the ECU 10 determines whether the vehicle VH has stopped. If the vehicle VH is not stopped (No), the ECU 10 returns to the determination process of step S140. On the other hand, if the vehicle VH is stopped (Yes), the ECU 10 terminates this routine.

In step S150, the ECU 10 activates the alarm. Next, in step S160, the ECU 10 determines whether or not the activation condition of the automatic brake is satisfied, i.e., whether or not the own vehicle VH is likely to collide with the obstacle. Specifically, if the process advances to step S160 without passing through the threshold value changing process of step S130, the ECU 10 determines whether or not the distance D between the own vehicle VH and the obstacle OJ is equal to or less than the reference automatic brake threshold value Dv2. On the other hand, if the process advances to step S160 through the threshold value changing process of step S130, the ECU 10 determines whether or not the distance D between the own vehicle VH and the obstacle OJ is equal to or less than the changed automatic brake threshold value Dv2′. When the activation condition of the automatic brake is satisfied (Yes), the ECU 10 advances the process to step S170. On the other hand, when the activation condition of the automatic brake is not satisfied (No), the ECU10 advances the process to step S165.

In step S170, the ECU 10 activates the automatic brake and then terminates this routine. When the process advances from step S160 to step S165, in step S165, the ECU 10 determines whether the vehicle VH is stopped. If the vehicle VH is not stopped (No), the ECU 10 returns to the determination process of step S160. On the other hand, if the vehicle VH is stopped (Yes), the ECU 10 terminates this routine.

In the above, the vehicle control device, the vehicle control method and the program according to the at least one embodiment have been described, but the present disclosure is not limited to the above-mentioned at least one embodiment, and various modifications are possible within the range not departing from the object of the present disclosure.

For example, in the above embodiment, both the reference alarm threshold value Dv1 and the reference automatic brake threshold value Dv2 are changed when it is determined that the vehicle VH is present at the registered location, but it may be configured to change only one of the reference alarm threshold value Dv1 and the reference automatic brake threshold value Dv2. Also in this case, when the driver attempts to park the vehicle VH in the parking lot at the registered location, either one of the alarm and the automatic brake becomes difficult to activate, so that it is possible to effectively suppress the driver from being troubled.

What is claimed is:

1. A vehicle control device configured to execute either or both an alarm and an automatic brake for avoiding an own vehicle from collide with an object, when a distance between the own vehicle and the object detected by a sensor for detecting the object present around the own vehicle becomes less than or equal to a predetermined threshold value,
wherein the vehicle control device is configured to:
determine whether or not a specific condition in which a current position of the own vehicle is located at a predetermined registered location is satisfied; and
change the threshold value so that either or both the alarm and the automatic brake are difficult to be activated, when the specific condition is satisfied.

2. The vehicle control device according to claim 1,
wherein the vehicle control device is configured to:
execute the alarm, when the distance between the own vehicle and the object becomes equal to or smaller than a predetermined first threshold value;
execute the automatic brake, when the distance between the own vehicle and the object becomes equal to or smaller than a predetermined second threshold value smaller than the first threshold value; and.
decreases both the first threshold value and the second threshold value so that the alarm and the automatic brake are difficult to be activated, when the specific condition is satisfied.

3. The vehicle control device according to claim 1,
wherein the predetermined registered location is a parking lot having a narrow parking area, and is registered by accepting a registering request from a user of the own vehicle.

4. A vehicle control method which is applied to a vehicle, the vehicle comprising a control device configured to executes either or both an alarm and an automatic brake for avoiding an own vehicle from collide with an object, when a distance between the own vehicle and the object detected by a sensor for detecting the object present around the own vehicle becomes less than or equal to a predetermined threshold value,
wherein the vehicle control method comprising:
determining whether or not a specific condition in which a current position of the own vehicle is located at a predetermined registered location is satisfied; and
changing the threshold value so that either or both the alarm and the automatic brake are difficult to be activated, when the specific condition is satisfied.

5. A program which is applied to a vehicle, the vehicle comprising a control device configured to executes either or both an alarm and an automatic brake for avoiding an own vehicle from collide with an object, when a distance between the own vehicle and the object detected by a sensor for detecting the object present around the own vehicle becomes less than or equal to a predetermined threshold value,
wherein the program causes an electronic control unit of the vehicle to execute:
determining whether or not a specific condition in which a current position of the own vehicle is located at a predetermined registered location is satisfied; and
changing the threshold value so that either or both the alarm and the automatic brake are difficult to be activated, when the specific condition is satisfied.
